(19) United States
(12) Patent Application Publication
(10) Pub. No.: US 2017/0228058 A1
(43) Pub. Date: Aug. 10, 2017

(54) TOUCH PANEL ASSEMBLY AND PORTABLE ELECTRONIC DEVICE

(71) Applicant: HTC Corporation, Taoyuan City (TW)

(72) Inventors: Po-Chin Huang, Taoyuan City (TW); Shih-Po Chien, Taoyuan City (TW); Chin-Kuei Wen, Taoyuan City (TW); Jui-Liang Chen, Taoyuan City (TW)

(21) Appl. No.: 15/016,290

(22) Filed: Feb. 5, 2016

(51) Int. Cl. G06F 3/044

(52) U.S. Cl. CPC G06F 3/044; G06F 2203/04102; G06F 2203/04103

(57) ABSTRACT

A touch panel assembly includes a touch panel and a flexible circuit board structure. The touch panel includes a sensing array, pads and connecting traces. The sensing array includes sensing units. The pads are disposed on a bonding region of the touch panel. The bonding region is located at a side of the sensing array. The connecting traces are located outside the sensing array and electrically connect the sensing units to the pads to actuate the sensing array. The flexible circuit board structure includes bonding portions and at least one key portion. Each bonding portion is disposed at the bonding region and includes a plurality of terminals electrically connected to the pads. The key portion includes a key circuit. The key portion is disposed between any two adjacent bonding portions. The bonding portions and the key portion are arranged along a direction substantially parallel to the side.

### BACKGROUND OF THE INVENTION

Field of the Invention

The application generally relates to a touch panel assembly and a portable electronic device. More particularly, the disclosure relates to a capacitive touch panel assembly and a portable electronic device using the capacitive touch panel assembly.

Description of Related Art

In recent years, along with the rapid advancement and wide application of information technologies, wireless mobile communications, and information appliances, conventional input devices such as keyboards and mice of many information products have been replaced by touch panels in order to offer convenience, small volume, light weight, and intuitional experiences to the users.

Touch panels can be categorized into resistive touch panels, capacitive touch panels, optical touch panels, acoustic wave touch panels, and electromagnetic touch panels according to the adopted touch-sensing techniques. Compared to other types of touch panels, capacitive touch panel offers quick response, high reliability, and high definition therefore is broadly applied to various handheld electronic devices. Generally, in a capacitive touch panel, a plurality of driving lines and a plurality of sensing lines are intersected to form a sensing array, so that a surface sensing effect can be achieved. As such, when a user touches the touch panel with a finger, the touch panel determines the position touched by the finger according to capacitance variation on the sensing array.

However, peripheral circuits of the touch panel or traces for connecting the electrodes take up layout space on the touch panel. Besides, a pad bonding region should be reserved around the touch panel to allow external circuits, such as a flexible circuit board, to be electrically connected to the sensing array, so as to input driving signals or output sensing signals. In addition, a physical key is often disposed at a periphery region of a portable electronic device. Thereby, when a user presses the physical key, a corresponding frequently used function can be activated quickly in order to shorten the time spent on searching and opening the function, but the disposition of the physical key also takes up the layout space of the touch panel.

### SUMMARY OF THE INVENTION

The application is directed to a touch panel assembly, which utilizes the layout space on the periphery of the touch panel to dispose the physical key.

The application is directed to a portable electronic device using the above-mentioned touch panel assembly to reduce the overall size of the portable electronic device.

The application provides a touch panel assembly includes a touch panel and a flexible circuit board structure. The touch panel includes a sensing array, pads and connecting traces. The sensing array includes a plurality of sensing units. The pads are disposed on a bonding region of the touch panel, wherein the bonding region is located at a side of the sensing array. The connecting traces are located outside the sensing array and electrically connecting the sensing units and the corresponding pads to actuate the sensing array. The flexible printed circuit (FPC) board structure includes a plurality of bonding portions and at least one key portion. The bonding portions are extended to and disposed at the bonding region, and each of the bonding portions comprises a plurality of terminals electrically connected to the corresponding pads respectively. The at least one key portion includes a key circuit, and the at least one key portion disposed between any two adjacent bonding portions, wherein the bonding portions and the at least one key portion are arranged along a direction substantially parallel to the side.

The application provides a portable electronic device including a housing, a display module, a touch panel and a flexible printed circuit (FPC) board structure. The housing has an opening. The display module is disposed in the housing and the opening exposes a display surface of the display module. The touch panel is disposed on the display surface. The touch panel includes a sensing array, pads and connecting traces. The sensing an⁻ay includes a plurality of sensing units. The pads are disposed on a bonding region of the touch panel, wherein the bonding region is located at a side of the sensing array. The connecting traces are located outside the sensing array and electrically connecting the sensing units and the corresponding pads to actuate the sensing array. The flexible printed circuit (FPC) board structure includes a plurality of bonding portions and at least one key portion. The bonding portions are extended to and disposed at the bonding region, and each of the bonding portions comprises a plurality of terminals electrically connected to the corresponding pads respectively. The at least one key portion includes a key circuit, and the at least one key portion disposed between any two adjacent bonding portions, wherein the bonding portions and the at least one key portion are arranged along a direction substantially parallel to the side.

In light of the foregoing, in the present application, the key portion of the portable electronic device is disposed on the FPC board structure of the touch panel assembly. Moreover, the key portion and the bonding portions of the FPC board structure are arranged along the direction parallel to the side of the sensing array and connected to the bonding region of the touch panel, and the key portion is disposed between any two adjacent bonding portions. Accordingly, the key portion of the portable electronic device can be disposed at the bonding region of the touch panel along with the bonding portions, so as to save layout space of the touch panel. Thereby, the layout space at a periphery of the touch panel can be efficiently utilized, such that the layout of the touch panel can be more compact. In addition, the application may also improve the space utilization of the portable electronic device using the touch panel assembly, so as to facilitate in reducing the overall size of the portable electronic device.

The accompanying drawings are included to provide a further understanding of the application, and are incorporated in and constitute a part of this specification. The drawings illustrate embodiments of the application and, together with the description, serve to explain the principles of the application.

### BRIEF DESCRIPTION OF THE DRAWINGS

FIG. 1 illustrates a portable electronic device according to an embodiment of the invention.

FIG. 2 illustrates a top view of a touch panel according to an embodiment of the invention.

FIG. 3 illustrates a partial top view of a touch panel according to an embodiment of the invention.

FIG. 4 illustrates an exploded view of a flexible printed circuit board structure according to an embodiment of the invention.

FIG. 5 illustrates a schematic view of a flexible printed circuit board structure before folded according to an embodiment of the invention.

FIG. 6 illustrates a schematic view of the flexible printed circuit board structure in FIG. 5 after folded.

FIG. 7 illustrates a top view of the flexible printed circuit board structure according to an embodiment of the invention.

FIG. 8 illustrates a partial cross-sectional view taken along line I-I of the flexible printed circuit board structure in FIG. 7.

### DESCRIPTION OF THE EMBODIMENTS

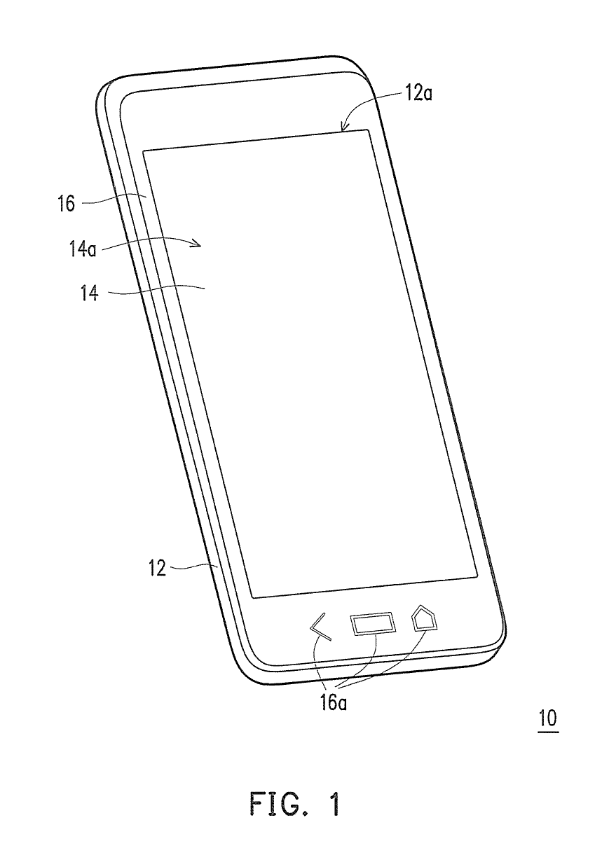

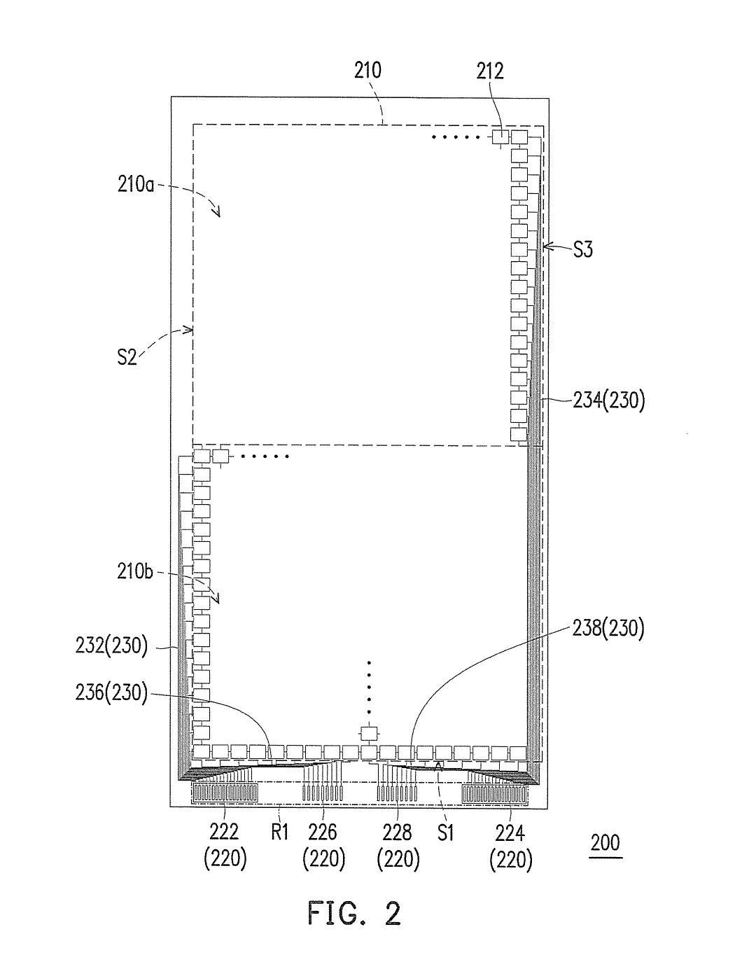

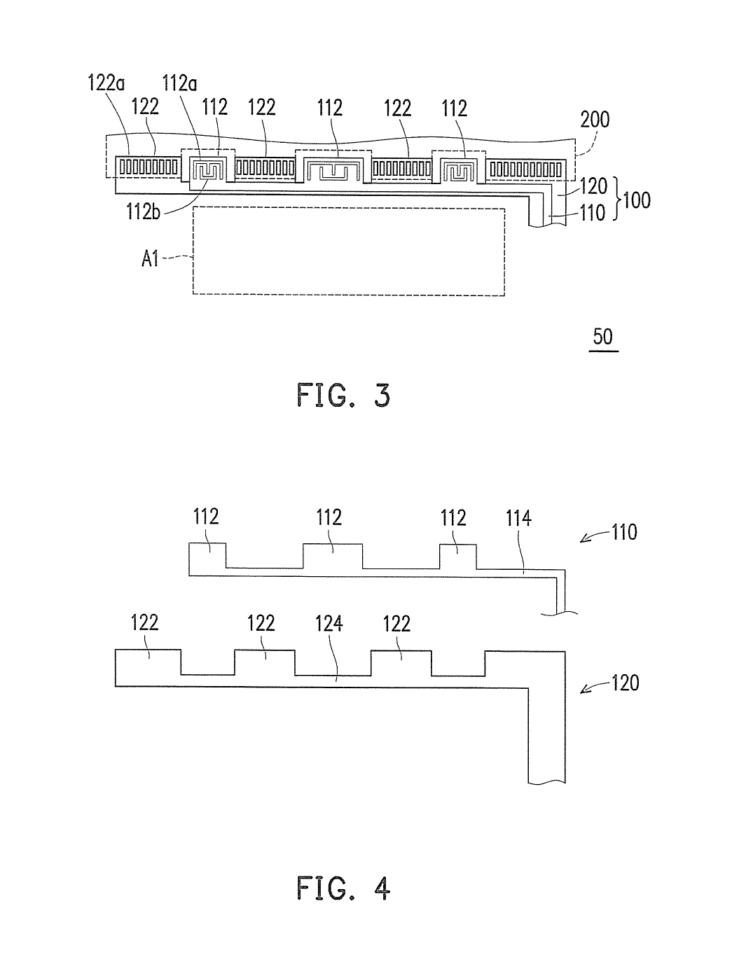

FIG. 1 illustrates a portable electronic device according to an embodiment of the invention. FIG. 2 illustrates a top view of a touch panel according to an embodiment of the invention. FIG. 3 illustrates a partial top view of a touch panel according to an embodiment of the invention. The portable electronic device 10 of the present embodiment may be a smart phone as shown in FIG. 1. Certainly, the present embodiment is merely for illustration. In other embodiments, the portable electronic device 10 of the application may also be any portable electronic device having touch-control function such as a tablet PC, an e-book, etc. Referring to FIG. 1 to FIG. 3, the portable electronic device 10 of the present embodiment includes a housing 12, a display module 14, a transparent cover plate 16, a flexible printed circuit (FPC) board structure 100 and a touch panel 200. The housing 12 has an opening 12a as shown in FIG. 1. The display module 14 is disposed in the housing 12, and the opening 12a exposes a display surface 14a of the display module 14. The touch panel 200 shown in FIG. 2 may be disposed on the display surface 14a, and the FPC board structure 100 may be bended to electrically connect the touch panel 200 and a host module of the portable electronic device 10. The transparent cover plate 16 is disposed on the touch panel 200 and covers the opening 12a of the housing 12. The transparent cover plate 16 has at least one light previous pattern 16a. The light pervious pattern 16a may be the key pattern of the portable electronic device 10.

In the present embodiment, the FPC board structure 100 and the touch panel 200 may be assembled together to form the touch panel assembly 50 shown in FIG. 3. The touch panel 200 as shown in FIG. 2 includes a sensing array 210, a plurality of pads 220 and a plurality of connecting traces 230. The sensing array 210 includes a plurality of sensing units 212. The sensing units 212 are connected to one another through a plurality of wires to form a plurality of sensing strings. Thereby, when a user touches the touch panel 200 with his finger, capacitance variation would occur at the position where the finger touches the touch panel. The capacitance variation would be converted to a control signal and transmitted to an external circuit, and the control signal is processed by a processor such that a command is output to control the portable electronic device 10. The pads 220 are disposed at a bonding region R1 of the touch panel 200, wherein the bonding region R1 is located at a side S1 of the sensing array 210. The connecting traces 230 are disposed outside the sensing array 210 and electrically connect the sensing units 212 to the pads 220 to activate the sensing units 212.

In detail, referring to FIG. 2, the pads 220 may include a plurality of first pads 222, a plurality of second pads 224, a plurality of third pads 226 and a plurality of fourth pads 228, which are all disposed at the bonding region R1 of the touch panel 200. The connecting traces 230 may include a plurality of first connecting traces 232, a plurality of second connecting traces 234, a plurality of third connecting traces 236 and a plurality of fourth connecting traces 238, wherein the first connecting traces 232 are disposed at a side S2 of the touch panel 200 to electrically connect the sensing units 212 located in a lower region 210b of the touch panel 200 to the corresponding first pads 222, and the second connecting traces 234 are disposed at a side S3 of the touch panel 200 to electrically connect the sensing units 212 located in an upper region 210a of the touch panel 200 to the corresponding second pads 224. Accordingly, the sensing units 212 are divided into two regions 210a and 210b and respectively connected to the corresponding pads 222 and 224 through the connecting traces 232 and 234 located at the two sides S2 and S3, so as to save the layout space for the connecting traces 230 on the touch panel 200. Similarly, the third connecting traces 236 and the fourth connecting traces 238 are disposed at the side S1 of the touch panel 200, so as to electrically connect the sensing units 212 located at the side S1 to the corresponding third pads 226 and the corresponding fourth pads 228.

Referring to FIG. 2 and FIG. 3, the FPC board structure 100 includes at least one key portion 112 and a plurality of bonding portions 122. The bonding portions are extended to and disposed at the bonding region R1 of the touch panel 200. Each of the bonding portions 122 includes a plurality of terminals 122a to electrically connect the corresponding pads 220 in the bonding region R1. The key portion 112 is disposed between any two adjacent bonding portions 122, and the bonding portions 122 and the key portion 112 are disposed along a direction substantially parallel to the side S1. In the present embodiment, a number of the key portion 112 may be plural (three is illustrated), and the key portions 112 and the bonding portions 122 are disposed in an alternate manner along the direction substantially parallel to the side S1. For example, the three key portions 112 shown in FIG. 3 are disposed between the first pads 222 and the second pads 224, between the second pads 224 and the third pads 226, and between the third pads 226 and the fourth pads 228 as shown in FIG. 2 respectively. Certainly, the present embodiment is merely for illustration, the application does not limit the number of the key portion 112 as long as the key portion 112 is disposed between two adjacent bonding portions 122 and arranged along the direction parallel to the side S1 with the bonding portion 122. In addition, the key portion 112 of the embodiment is a physical key. The key portion 112 is different from a virtual key displayed by the display module.

With such structural configuration, the key portion 112 of the application is disposed between any two adjacent bonding portions 122, such that the key portion 112 of the portable electronic device 10 may be disposed in the layout region of the touch panel to save the layout space for the connecting traces 230 on the touch panel 200.

Thereby, the layout space at a periphery of the touch panel 200 can be efficiently utilized, such that the layout of the touch panel 200 is more compact. In addition, the application may further improve the space utilization of the portable electronic device 10 using the touch panel assembly 50, helps reducing the overall size of the portable electronic device 10, and provides a physical key formed by the key portion 112.

Specifically, the key portion 112 may include a key circuit. In the present embodiment, in detail, the key portion 112 may function as a physical key of a smart phone. The key circuit may include a first key electrode pattern 112a and a second key electrode pattern 112b. Thereby, when a user touches the key portion 112 with his finger, capacitance variation occurs between the first key electrode pattern 112a and the second key electrode pattern 112b and a control signal is generated accordingly. Certainly, in other embodiments, the key portion 112 may also be a light sensitive key, strength sensitive key, etc. The application does not limit the types of the key portion 112 and the methods for generating the control signal. The key portion 112 may be located right below the light pervious pattern 16a shown in FIG. 1, and each of the key portions 112 may have different functions such as “back to previous”, “back to main screen”, etc., such that the user may control the portable electronic device 10 to operate the corresponding functions by touching the light pervious pattern 16a to generate the corresponding control signal.

It should be noted that the FPC board structure 100 may be embodied in a plurality of embodiments, which can all achieve the effect of the key portion 112 located between any two adjacent bonding portions 122 and arranged along the direction parallel to the side S1 with the bonding portions 122. Three of the embodiments are illustrated in detail hereinafter, but the embodiments of application are not limited thereto.

FIG. 4 illustrates an exploded view of a flexible printed circuit board structure according to an embodiment of the invention. In the present embodiment, the FPC board structure 100 may include a first FPC board 110, a second FPC board 120 and a shielding metal layer. The first FPC board 110 includes the above-mentioned key portions 112, and the second FPC board 122 includes the above-mentioned bonding portion 122. The first FPC 110 is stacked on the second FPC board 120, such that the key portions 112 are disposed between any two adjacent bonding portions 122, and the bonding portions 122 are disposed along the direction substantially parallel to the side S1 with the key portions 112. Moreover, the shielding metal layer is at least disposed at an overlapping portion between the first FPC board 110 and the second FPC board 120 to reduce the electromagnetic coupling effect between the first FPC board 110 and the second FPC board 120. In detail, the shielding metal layer may be a part of the first FPC board 110 or a part of the second FPC board 120. The shielding metal layer may also be a metal layer independent from the first FPC board 110 and the second FPC board 120.

To be more specific, the first FPC board 110 may further include a first connecting portion 114 connected to the key portions 112. The key portions 112 protrude from the first connecting portion 114 and are extended to the bonding region R1 of the touch panel 200. Similarly, the second FPC board 120 may include a second connecting portion 124 connected to the bonding portions 122. The bonding portions 122 protrude from the second connecting portion 124 and are extended to the bonding region R1 of the touch panel 200. The first connecting portion 114 is stacked on the second connecting portion 124, such that the key portion 112 is located between any two adjacent bonding portions 122. Namely, in the present embodiment, the first FPC board 110 having the key portions 112 is stacked on the second FPC board 120 having the bonding portions 122, such that the key portions 112 are located between any two adjacent bonding portions 122. The key portions 112 and the bonding portions 122 are disposed collinearly at the side S1 of the touch panel 200 to form the FPC board structure 100 shown in FIG. 3.

In addition, below the FPC board structure 100, there is a circuit clearance region A1 as shown in FIG. 3. An antenna module is disposed in the circuit clearance region A1, so that circuit layout must avoid this region; namely, the FPC board structure 100 must bypass this region, and the FPC board structure 100 or other circuit must keep a certain distance from the antenna module to reduce the impact of electromagnetic coupling on the antenna module. Therefore, in the present embodiment, the disposition of the FPC board structure 100 must bypass the circuit clearance region A1.

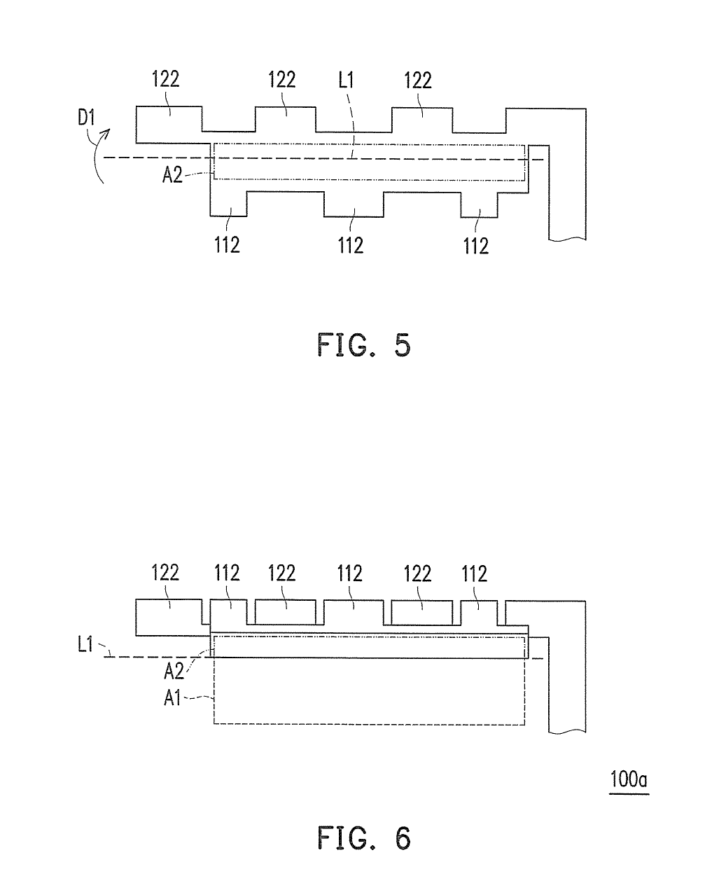

FIG. 5 illustrates a schematic view of a flexible printed circuit board structure before folded according to an embodiment of the invention. FIG. 6 illustrates a schematic view of the flexible printed circuit board structure in FIG. 5 after folded. It should be noted here, the FPC board structure 100a in the present embodiment is similar to the FPC board structure 100 shown in the FIG. 3 to FIG. 4. Therefore, the present embodiment adopts the same reference numbers and a part of the contents from the above embodiment, wherein the same reference numbers are adopted to represent same or similar elements and the description of similar technical content is omitted. The details of the omitted parts may reference to the previous embodiment, and will not be repeated in the present embodiment. Referring to FIG. 5 to FIG. 6, the differences between FPC board structure 100a in the present embodiment is similar to the FPC board structure 100 shown in the FIG. 3 to FIG. 4 are described as following.

In the present embodiment, the FPC board structure 100a may be integrally formed, and include a folding line L1 parallel to the side S1. The bonding portions 122 and the key portions 112 are located at two opposite sides of the folding line L1 respectively. The FPC board structure 100a is folded along the folding line L1, so the key portions 112 are located between two adjacent bonding portions 122. Namely, in the present embodiment, the bonding portions 122 and the key portions 112 are respectively located at two opposite sides of the FPC board structure 100 a, and then the FPC board structure 100a is folded along the folding line L1, such that the key portions 112 are stacked between two adjacent bonding portions 122. Moreover, the FPC board structure 100a further includes a shielding metal layer, which at least is disposed at an overlapping portion of the folded FPC board structure 100 a, so as to reduce electromagnetic coupling effect on the overlapping portion of the FPC board structure 100 a.

In addition, the FPC board structure 100a may further include a circuit clearance region A1, and the antenna module is disposed in the circuit clearance region A1, so that circuit layout must avoid this region. In the present embodiment, the FPC board structure 100a may be partially overlapped with the FPC board structure 100 a. Under such circumstances, the circuit on the FPC board structure 100a must bypass this region. Namely, that circuit layout must avoid an overlapping region A2 where the FPC board structure 100a and the circuit clearance region A1 are overlapped, and must keep a certain distance from the antenna module, so as to reduce the impact of electromagnetic coupling on the antenna module.

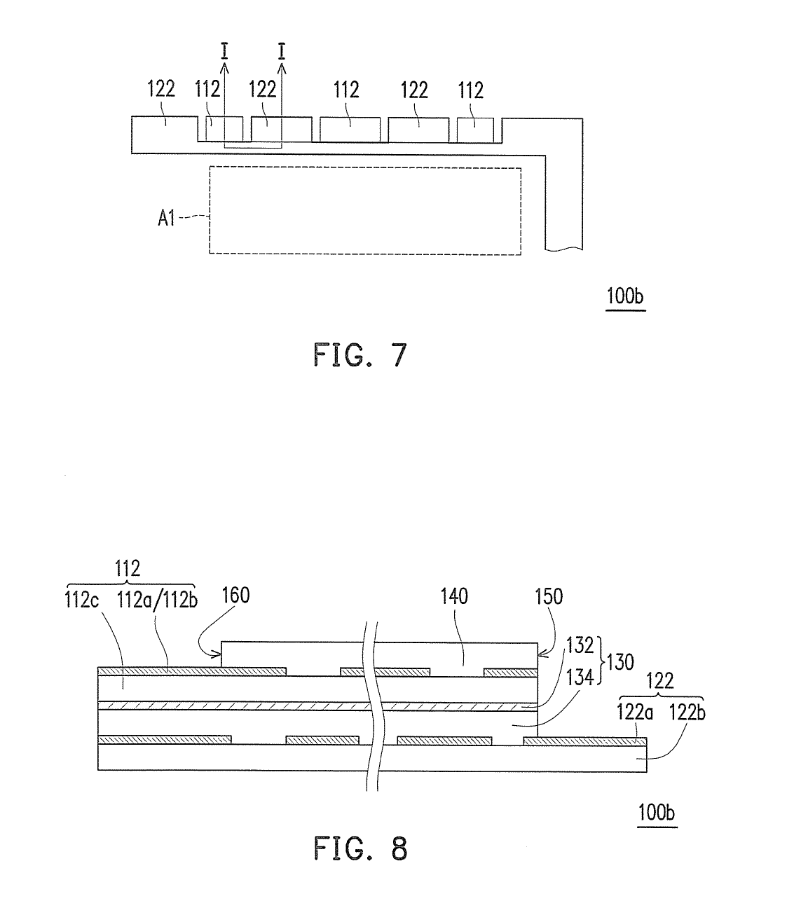

FIG. 7 illustrates a top view of the flexible printed circuit board structure according to an embodiment of the invention. FIG. 8 illustrates a partial cross-sectional view taken along line I-I of the flexible printed circuit board structure in FIG. 7. It should be noted here, the FPC board structure 100b in the present embodiment is similar to the FPC board structure 100 shown in the FIG. 3 to FIG. 4. Therefore, the present embodiment adopts the same reference numbers and a part of the contents from the above embodiment, wherein the same reference numbers are adopted to represent same or similar elements and the description of similar technical content is omitted. The details of the omitted parts may reference to the previous embodiment, and will not be repeated in the present embodiment. Referring to FIG. 7 to FIG. 8, the differences between FPC board structure 100b in the present embodiment is similar to the FPC board structure 100 shown in the FIG. 3 to FIG. 4 are described as following.

In the present embodiment, the FPC board structure 100b may be a multi-layer circuit board structure, which may include a first dielectric layer 122b, a bonding circuit layer 122a, a second dielectric layer 112c, a key circuit layer 112a/112b and a third dielectric layer 140. In addition, the FPC board structure 100b may further include a shielding laminating layer 130 which includes a shielding metal layer 132 and a fourth dielectric layer 134, and is laminated between the key circuit layer 112a/112b and the bonding circuit layer 122a. In detail, the bonding circuit layer 122a is disposed on the first dielectric layer 112b; the fourth dielectric layer 134 is disposed on the bonding circuit layer 122a; the shielding metal layer 132 is disposed on the fourth dielectric layer 134, so as to be located between the key circuit layer 112a/112b and the bonding circuit layer 122a. The second dielectric layer 112c is disposed on the shielding metal layer 132, the key circuit layer 112a/112b is disposed on the second dielectric layer 112c, and the third dielectric layer 140 is disposed on the key circuit layer 112a/112b. Moreover, the FPC board structure 100b may further include at least one first opening 160 and a plurality of second openings 150. The first opening 160 partially exposes the key circuit layer 112a/112b to form the key portions 112, and the second openings 150 partially expose the bonding circuit layer 122a to form the bonding portions 122.

To put it simply, the FPC board structure 100b of the present embodiment is a multi-layer circuit board structure including the key circuit layer 112a/112b and the bonding circuit layer 122a, and the key circuit layer 112a/112b and the bonding circuit layer 122a are partially exposed by the first openings 160 and the second openings 150 to form the exposed key portions 112 and the exposed bonding portions 122. In addition, the first openings 160 are located between the corresponding two adjacent second openings 150, such that the key portions 112 are located between the corresponding two adjacent bonding portions 122, and the key portions 112 and the bonding portions 122 are arranged along the direction parallel to the side S1 of the touch panel 200 to form the FPC board structure 100b as shown in FIG. 7.

In addition, below the FPC board structure 100b, there may also be a circuit clearance region A1 as shown in FIG. 7. The antenna module is disposed in the circuit clearance region A1, so that circuit layout must avoid this region; namely, the FPC board structure 100b must bypass this region, and the FPC board structure 100b must keep a certain distance from the antenna module to reduce the impact of electromagnetic coupling on the antenna module. Therefore, in the present embodiment, the disposition of the FPC board structure 100 must bypass the circuit clearance region A1.

In sum, in the present application, the key portion of the portable electronic device is disposed on the FPC board structure of the touch panel assembly. The key portion and the bonding portions of the FPC board structure are arranged along the direction parallel to the side of the sensing array and connected to the bonding region of the touch panel, and the key portion is disposed between any two adjacent bonding portions. Accordingly, the key portion of the portable electronic device can be disposed at the bonding region of the touch panel along with the bonding portions, so as to save layout space of the touch panel. Thereby, the layout space at a periphery of the touch panel can be efficiently utilized, such that the layout of the touch panel can be more compact. In addition, the application improves the space utilization of the portable electronic device using the touch panel assembly, facilitates in reducing the overall size of the portable electronic device, and provides a physical key formed by the key portion.

It will be apparent to those skilled in the art that various modifications and variations can be made to the structure of the present application without departing from the scope or spirit of the application. In view of the foregoing, it is intended that the present application cover modifications and variations of this invention provided they fall within the scope of the following claims and their equivalents.

What is claimed is:

1. A touch panel assembly, comprising:
a touch panel, comprising:
a sensing array, comprising a plurality of sensing units;
a plurality of pads, disposed on a bonding region of the touch panel, wherein the bonding region is located at a side of the sensing array; and
a plurality of connecting traces, located outside the sensing array and electrically connecting the sensing units and the corresponding pads to actuate the sensing array; and
a flexible printed circuit (FPC) board structure, comprising:
a plurality of bonding portions, extended to and disposed at the bonding region, and each of the bonding portions comprising a plurality of terminals electrically connected to the corresponding pads respectively; and
at least one key portion, comprising a key circuit, and the at least one key portion disposed between any two adjacent bonding portions, wherein the bonding portions and the at least one key portion are arranged along a direction substantially parallel to the side.

2. The touch panel assembly as claimed in claim 1, wherein a number of the at least one key portion is plural, and the key portions and the bonding portions are disposed along the direction substantially parallel to the side in an alternate manner.

3. The touch panel assembly as claimed in claim 1, wherein the key circuit comprises a first key electrode pattern and a second key electrode pattern.

4. The touch panel assembly as claimed in claim 1, wherein the FPC board structure comprises a first FPC board and a second FPC board, the first FPC board comprises the at least one key portion, the second FPC board comprises the bonding portions, and the first FPC board is stacked on the second FPC board.

5. The touch panel assembly as claimed in claim 4, wherein the FPC board structure further comprises a shielding metal layer at least disposed at an overlapping portion between the first FPC board and the second FPC board.

6. The touch panel assembly as claimed in claim 4, wherein the first FPC board further comprises a first connecting portion connecting the at least one key portion, the at least one key portion protrudes from the first connecting portion and is extended to the bonding region, the second FPC board further comprises a second connecting portion, the bonding portions protrude from the second connecting portion and is extended to the bonding region, the first connecting portion is stacked on the second connecting portion, and the at least one key portion is located between any two adjacent bonding portions.

7. The touch panel assembly as claimed in claim 1, wherein the FPC board structure further comprises a folding line parallel to the side, the bonding portions and the at least one key portion are respectively located at two opposite sides of the folding line, the FPC board structure is folded along the folding line, such that the at least one key portion is located between any two adjacent bonding portions.

8. The touch panel assembly as claimed in claim 7, wherein the FPC board structure further comprises a shielding metal layer at least disposed at an overlapping portion of the folded FPC board structure.

9. The touch panel assembly as claimed in claim 1, wherein the FPC board structure further comprises a first dielectric layer, a bonding circuit layer, a second dielectric layer, a key circuit layer and a third dielectric layer, at least one first opening and a plurality of second openings, the bonding circuit layer is disposed on the first dielectric layer, the second dielectric layer is disposed on the bonding circuit layer, the key circuit layer is disposed on the second dielectric layer, the third dielectric layer is disposed on the key circuit layer, the at least one first opening partially exposes the key circuit layer to form the key portion, and the second openings partially expose the bonding circuit layer to form the bonding portions.

10. The touch panel assembly as claimed in claim 9, wherein the FPC board structure further comprises a shielding metal layer and a fourth dielectric layer, the shielding metal layer is disposed on the fourth dielectric layer and located between the key circuit layer and the bonding circuit layer, and the shielding metal layer and the fourth dielectric layer exposes the bonding portions.

11. A portable electronic device, comprising:
a housing, having an opening;
a display module, disposed in the housing and the opening exposing a display surface of the display module;
a touch panel, disposed on the display surface, and the touch panel comprising:
a sensing array, comprising a plurality of sensing units;
a plurality of pads, disposed on a bonding region of the touch panel,
wherein the bonding region is located at a side of the sensing array; and
a plurality of connecting traces, located outside the sensing array and electrically connecting the sensing units and the corresponding pads to actuate the sensing array; and
a flexible printed circuit (FPC) board structure, comprising:
a plurality of bonding portions, extended to and disposed at the bonding region, and each of the bonding portions comprising a plurality of terminals electrically connected to the corresponding pads respectively; and
at least one key portion, comprising a key circuit, and the at least one key portion disposed between any two adjacent bonding portions, wherein the bonding portions and the at least one key portion are arranged along a direction substantially parallel to the side.

12. The portable electronic device as claimed in claim 11, wherein a number of the at least one key portion is plural, and the key portions and the bonding portions are disposed along a direction substantially parallel to the side in an alternate manner.

13. The portable electronic device as claimed in claim 11, wherein the key circuit comprises a first key electrode pattern and a second key electrode pattern.

14. The portable electronic device as claimed in claim 11, wherein the FPC board structure comprises a first FPC board and a second FPC board, the first FPC board comprises the at least one key portion, the second FPC board comprises the bonding portions, and the first FPC board is stacked on the second FPC board.

15. The portable electronic device as claimed in claim 14, wherein the FPC board structure further comprises a shielding metal layer at least disposed at an overlapping portion between the first FPC board and the second FPC board.

16. The portable electronic device as claimed in claim 14, wherein the first FPC board further comprises a first connecting portion connecting the at least one key portion, the at least one key portion protrudes from the first connecting portion and is extended to the bonding region, the second FPC board further comprises a second connecting portion, the bonding portions protrude from the second connecting portion and is extended to the bonding region, the first connecting portion is stacked on the second connecting portion, and the at least one key portion is located between any two adjacent bonding portions.

17. The portable electronic device as claimed in claim 11, wherein the FPC board structure further comprises a folding line parallel to the side, the bonding portions and the at least one key portion are respectively located at two opposite sides of the folding line, the FPC board structure is folded along the folding line, such that the at least one key portion is located between any two adjacent bonding portions.

18. The portable electronic device as claimed in claim 17, wherein the FPC board structure further comprises a shielding metal layer at least disposed at an overlapping portion of the folded FPC board structure.

19. The portable electronic device as claimed in claim 11, wherein the FPC board structure further comprises a first dielectric layer, a bonding circuit layer, a second dielectric layer, a key circuit layer and a third dielectric layer, at least one first opening and a plurality of second openings, the bonding circuit layer is disposed on the first dielectric layer, the second dielectric layer is disposed on the bonding circuit layer, the key circuit layer is disposed on the second dielectric layer, the third dielectric layer is disposed on the key circuit layer, the at least one first opening partially exposes the key circuit layer to form the key portion, and the second openings partially expose the bonding circuit layer to form the bonding portions.

20. The portable electronic device as claimed in claim 19, wherein the FPC board structure further comprises a shielding metal layer and a fourth dielectric layer, the shielding metal layer is disposed on the fourth dielectric layer and located between the key circuit layer and the bonding circuit layer, and the shielding metal layer and the fourth dielectric layer exposes the bonding portions.
